(19) United States
(12) Patent Application Publication
(10) Pub. No.: US 2009/0234746 A1
(43) Pub. Date: Sep. 17, 2009

(54) Single use money transfer

(76) Inventors: Kurt Jensen, Kenosha, WI (US); Bryan Chance, Plano, TX (US)

Correspondence Address: HOWREY LLP - East, C/O IP DOCKETING DEPARTMENT, 2941 FAIRVIEW PARK DR, SUITE 200, FALLS CHURCH, VA, 22042-2924, US

(21) Appl. No.: 12/216,714

(22) Filed: Jul. 9, 2008

Related U.S. Application Data
(60) Provisional application No. 60/929,687, filed on Jul. 9, 2007.

(51) Int. Cl. G06Q 20/00; G06Q 30/00; G06Q 40/00

(52) U.S. Cl. 705/17; 705/21; 705/41

(57) ABSTRACT

A system, method, and apparatus for the secure and convenient provision of money. A prepaid card is purchased by a consumer, who then has the card activated. Information about the card and a security number provided by calling a number printed on the card is then sent to a recipient. Using that information, the recipient then receives an amount of money that correlates to the prepaid purchase amount.

### RELATED APPLICATIONS

This application claims the benefit of U.S. provisional Application No. 60/929,687 filed Jul. 9, 2007 and entitled Single Use Money Transfer. The foregoing application is hereby incorporated herein by reference.

### FIELD OF THE INVENTION

The invention relates generally to the transfer of money from one person to another. A consumer may purchase a prepaid card and use that card or the information stored on the card a single time to transfer money to a recipient around the world.

### BACKGROUND OF THE INVENTION

With the ever-increasing prevalence of international travel, immigration, and business, the need to quickly, confidently, and securely transfer money around the globe grows everyday. In response to this need, various schemes have been developed to allow people to transfer money globally. These methods may be generally described as attempts to extend domestic money transfer methods globally.

One simple method of transferring money is simply mailing a recipient a check or bank draft. This method of money transfer, while simple, has some severe limitations. For one, most checks or bank drafts must be physically transferred in order to affect the money transfer. Secondly, some financial institution convenient to the recipient must be willing to redeem the check or draft in order to allow the recipient to actually receive the value of the money transferred. Third, some customers may have difficulty cashing checks because of the potential for prohibitive fees involved in cashing checks.

To address the latter problem, people have developed specialized instruments such as bank checks, cashier's checks, and traveler's checks. If transferring money globally, however, these financial instruments still require physically transferring the instrument to the recipient in order to transfer the money. They also have other drawbacks, such as the need to purchase them from one of the few internationally recognized issuers.

Another way of globally transferring money has been through banking transfers and the wiring of money from one account to another. These, however, offer their own array of problems, from prohibitive costs for transferring small amounts of money to the need for both the payer and recipient to have accounts in banks setup for such wire transfers. Also there may be a significant number of people that may not, for various reasons, have access to a bank account that would allow them to cash a check, or receive a bank transfer at all. Moreover, even if someone had access to such a bank account, again the fees may be prohibitive.

The practice of pre-paying for goods and services is well known. Often people give and receive prepaid gift cards holding the value equivalent to a certain amount of money. Similarly, people often buy prepaid calling cards, which entitle them to either a certain dollar amount or number of calling minutes that they may use to place calls for which they would normally be billed.

What is needed then is a way to securely and conveniently provide any amount money to a recipient.

### SUMMARY OF THE INVENTION

The invention relates generally to providing money from one person to another. The invention makes use of single or limited-use prepaid cards which can be purchased from any store or other outlet. The value stored in a prepaid card may correlate to the purchase price paid at the authorized merchant location. A consumer could purchase such a card and after having it authorized, use it to provide a particular value of money to recipients around the world.

In one embodiment, the invention may be a system for providing value to a recipient, the system comprising: one or more value objects comprised of substantially unique identification information; one or more merchant terminals configured to communicate with one or more servers on a network; wherein said merchant terminals are configured to communicate with the one or more servers to authorize one or more value objects when said one or more value objects are purchased by one or more purchasers; wherein the one or more purchasers are allowed to communicate the unique identification information to one or more recipients; and wherein said servers authorize the transmission of value to the one or more recipients when presented with the authorized one or more value objects.

In another embodiment, the invention may be a method of providing value to a recipient, said method comprising the steps of: providing for purchase one or more value objects comprised of substantially unique identification information; allowing a purchaser to transmit the substantially unique identification information to at least one recipient; providing value to the at least one recipient upon presentation of the substantially unique value object information.

These and other objects and advantages of the invention will be apparent from the following description and the accompanying drawing.

### BRIEF DESCRIPTION OF THE DRAWINGS

It is believed the present invention will be better understood from the following description taken in conjunction with the accompanying drawing, which illustrates, in a non-limiting fashion, the best mode presently contemplated for carrying out the present invention, and in which like reference numerals designate like parts throughout the Figure, wherein:

FIG. 1 shows a flow chart of the process of one embodiment of the invention.

FIG. 2 depicts the front side of a prepaid money card in accordance with an embodiment of the invention.

FIG. 3. depicts the back side of a prepaid money card in accordance with an embodiment of the invention.

### DETAILED DESCRIPTION OF THE INVENTION

The present disclosure will now be described more fully with reference to the Figures in which an embodiment of the present invention is shown. The subject matter of this disclosure may, however, be embodied in many different forms and should not be construed as being limited to the embodiments set forth herein.

The present invention allows a consumer to purchase a prepaid money card. The appropriate card with a preset value may be selected by the consumer, who then purchases the card from an authorized merchant. The card may be activated by swiping its magnetic strip through an authorized terminal, which is known in the art. In another embodiment, the card may be activated by other means such as activating chips in a smart card or scanning a bar code. Once authorized, the consumer may contact a service representative via a phone number provided either on the card or at the time of purchase or via some other method known in the art. During such a phone call, a user may provide a customer service representative with any information that is required to meet local, federal, and international regulations. The consumer may, depending upon the embodiment, select an appropriate disbursal location or outlet where the intended recipient may collect the provided money. The customer service representative may then provide the consumer with a unique security identification number. The consumer may then contact the intended recipient. Contact may be done by telephone call, electronic mail (e-mail), or other methods known in the art. The recipient is informed of the unique identification number of the prepaid card, as well the unique security identification number provided by the customer service representative and the disbursal location or outlet. This information will then be used by the recipient to access the funds.

According to one embodiment, the present invention works by using a network of prepaid cards. Accordingly, prepaid money cards are produced by first generating a unique identification number in the money provisioning system. The identification number may be associated with a prepaid amount. This identification number is then encoded on the magnetic strip on the back of the card, as well as printed on the back of the card. The printed number may be covered by a material than can be easily scratched or wiped off of the back of the card. These cards are then distributed to retailers which, in turn, distribute them to consumers.

When a consumer wishes to provide money to another party, that consumer may choose an appropriate card from a commercial display, such as rack of prepaid cards or other display known in the art. If a prepaid value had been associated with the card's unique identification number, the cards may be marked with the appropriate prepaid value or may be available for purchase with a customizable value. After a consumer chooses the appropriate card, they then purchase the card at an authorized merchant location. The merchant accepts all payment for the card, including the amount to be provided and possibly an additional fee.

In one embodiment, the authorized merchant location is equipped with an authorizing terminal that is capable of reading the magnetic strip of the prepaid card and is connected to an authorizing network. In this embodiment, the merchant, while accepting payment for the card, swipes the card through the authorizing terminal. The authorizing terminal scans the unique identification number from the card and transmits that number to the authorizing network. At least one server resides on the authorizing network. This at least one server receives the number scanned and transmitted by the authorizing terminal. Upon receiving this number from the authorizing terminal, the server acknowledges that the card marked with the unique identification number has been authorized and is ready for use by a consumer.

After a card has been authorized at a merchant location, the card is then used by the consumer to provide money. In one embodiment, the consumer does so by first communicating with a customer service representative (CSR) at a telephone number printed on the back of the prepaid card or provided by the merchant at the point of sale. The CSR telephone number may, however, be provided at the point of purchase, a website, or other location. Contacting the CSR may also be accomplished by other means such as the Internet or by e-mail.

In one embodiment, after the consumer initiates communication, the CSR asks the consumer questions appropriate to ensure that any state, federal, or international regulations are being followed. After ensuring that providing the money to the recipient is in compliance with local, federal, or international regulations, the CSR then provides a unique security identification number to the consumer. This unique security identification number is associated with the unique identification number already associate with the card. The unique security identification number may also be associated with the value of the money to be provided with the card.

In one embodiment, after a consumer is provided a unique security identification number, the CSR then asks the consumer if they wish to place a phone call to the recipient. If the consumer so desires, the consumer (or the operator acting on behalf of the consumer) then places a call to the intended recipient and the consumer provides the recipient with the identification number of the prepaid card, as well as the unique security identification number now associated with the card. The recipient takes this knowledge, as well as a means of personal identification to a site equipped to disburse the appropriate amount of money. This disbursal location uses the card's identification number as well as the unique security identification number and ensures that the transaction is valid and proper. Upon ensuring identification of the recipient, the disbursal location provides to the recipient the appropriate amount of money.

Similarly, in some embodiments of the present invention, the consumer is an established member of the present invention's system. In that case, the consumer may choose to provide his/her own persona 1 number to the merchant at the time of purchase. In this embodiment, after purchasing the prepaid card, the consumer will contact a customer service representative or automated assistant via the phone number on the card or provided to the consumer when the card was purchased or some other method known in the art. However, in this instance, the consumer will provider his/her unique pre-registered number, rather than receive a number from a CSR. In this case, the consumer's unique pre-registered number will be verified, as well as the unique identification number of the prepaid card and the user will be asked if they would like to place a call to the recipient. In some embodiments of the invention, upon initiating communication with a customer service representative or automated assistant, the user may be asked if they have a unique pre-registered number or if a unique security identification number is needed. The system or person receiving the communication may then either provide a unique security identification number or proceed with the communication.

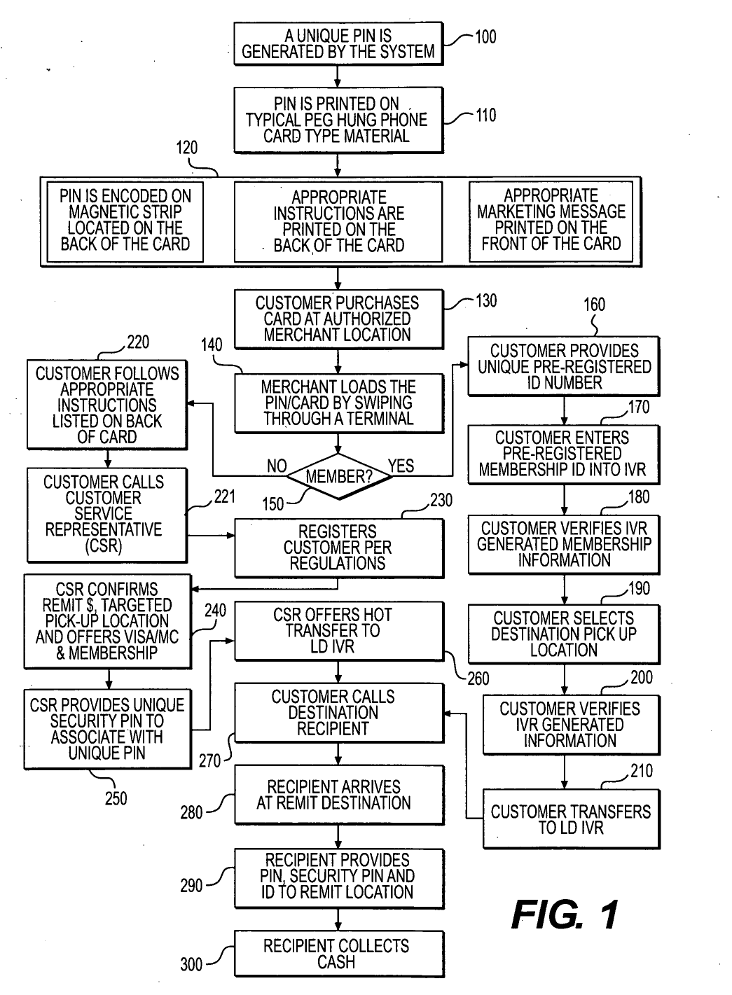

FIG. 1 depicts an embodiment of the present invention. This figure shows a flow chart of how an embodiment of the present invention may work.

As can be seen in the embodiment of the present invention depicted in FIG. 1, first a unique PIN (personal identification number) is generated by the system (step 100). Second, the PIN is printed on the back of a prepaid card (step 110). Third, the PIN is encoded onto the magnetic strip on the back of the card, as well as printing the card with the appropriate instructions and marketing messages (step 120). Then a customer selects and purchases a prepaid card of his/her choice (step 130). The merchant then loads the PIN/card by swiping it through the terminal located at the authorized merchant location (step 140).

In the embodiment depicted by the figure, a different process is then followed depending upon whether the consumer is a pre-registered member of the prepaid money network or not (step 150). If the consumer is a member, then the customer provides the unique, pre-registered identification number to the system (step 160). The customer calls and provides this number to an operator or automated system that answers customer calls (step 170). Once the customer verifies his/her membership information (step 180), the consumer then selects a location where the money will be remitted step (190). After the customer verifies the transaction's information (step 200), the customer may then call the intended recipient (step 210; step 270). The consumer then provides the intended recipient with the user's pre-registered number and the card's unique identification number. That information is taken by the recipient to the disbursal location where it is exchanged for the money to be provided (steps 280 to 300).

In the embodiment depicted by the figure, a different process is followed if the consumer is not a pre-registered member of the present invention's network. In that case, the consumer calls the number printed on the card or provided at the time of purchase (step 220; step 221). When that call is answered, the consumer is forced to answer a series of questions to ensure compliance with local, federal, and international regulations (step 230). After the regulation requirements have been met, the customer service representative confirms the disbursal amount and location (step 240). The CSR may also then offer the consumer the opportunity to purchase other goods or services or to join credit organizations such as Visa or Mastercard. The CSR then provides the consumer with a unique security identification number (step 250). The consumer may then be transferred to a system to handle long-distance calls or may otherwise call the recipient and provide the recipient with the unique identification number of the prepaid card, as well as the unique security identification number and disbursal location (step 260; step 270). At the disbursal location, the recipient then provides his/her identification, the unique identification number of the prepaid card, and the unique security identification number and receives the money provided.

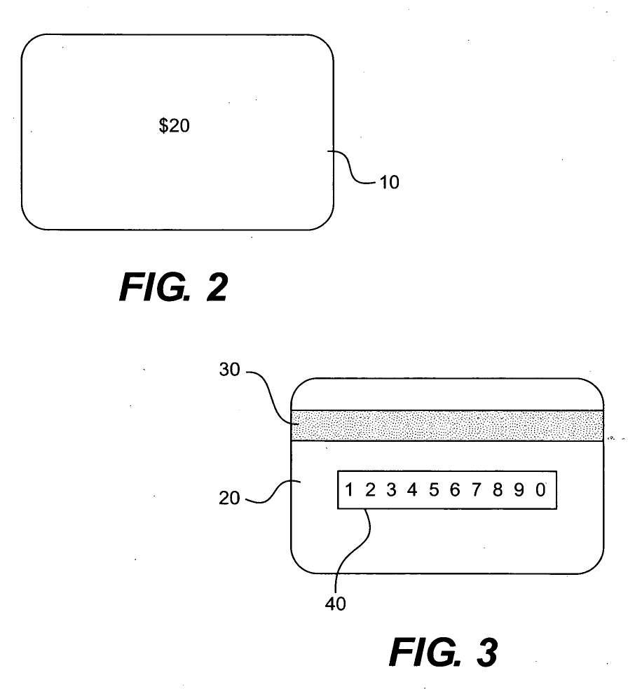

FIG. 2 depicts the front side 10 of a prepaid money card in-accordance with an embodiment of the invention. The front side 10 of a prepaid money card may show the denomination or value of the money provided as seen in FIG. 2. Branding or other marketing messages may also be shown on the front side of the prepaid card. Likewise, other information useful to a purchaser may be shown on the front side of the prepaid card.

FIG. 3. depicts the back side of a prepaid money card in accordance with an embodiment of the invention. According to an embodiment of the present invention, the back side of a prepaid card may have a magnetic strip 30 and a PIN or otherwise substantially unique number 40 shown on the back. The PIN or otherwise substantially unique number may be encoded onto magnetic strip 30. The PIN or otherwise substantially unique number 40 may also be covered with a material that may be scratched, torn, lifted, or otherwise removed from the card. This material may be configured so as to be substantially irreplaceable to prevent a person from removing the material, learning the number 40 and then replacing the material in the hopes of interfering with the use of the card or even stealing or otherwise expending the value of the card and then replacing the used card in the store or display.

It should be noted that although the card in FIGS. 2 and 3 is depicted as similar to a common credit card, the card may be formed in any usable shape. Likewise, the card may have additional material attached to it or otherwise packaged so as to be easily displayed, such as with a peg-type display common in many stores or a vending machine.

The foregoing descriptions of specific embodiments of the present invention are presented for purposes of illustration and description. They are not intended to be exhaustive or to limit the invention to the precise forms disclosed. Obviously, many modifications and variations are possible in view of the above teachings. While the embodiments were chosen and described in order to best explain the principles of the invention and its practical applications, thereby enabling others skilled in the art to best utilize the invention, various embodiments with various modifications as are suited to the particular use are also possible. The scope of the invention is to be defined only by the claims appended hereto, and by their equivalents.

1. A system for providing value to a recipient, the system comprising:
one or more value objects comprised of substantially unique identification information;
one or more merchant terminals configured to communicate with one or more servers on a network;
wherein said merchant terminals are configured to communicate with the one or more servers to authorize one or more value objects when said one or more value objects are purchased by one or more purchasers;
wherein the one or more purchasers are allowed to communicate the unique identification information to one or more recipients; and
wherein said servers authorize the transmission of value to the one or more recipients when presented with the authorized one or more value objects.

2. The system of claim 1, wherein transmission of value is comprised of dispersal of currency to the one or more recipients.

3. The system of claim 1, wherein the amount of the value transmitted is determined during purchasing of the one or more value objects.

4. The system of claim 1, wherein the one or more value objects are comprised of one or more plastic cards.

5. The system of claim 4, wherein the one or more plastic cards each contain at least one magnetic strip.

6. The system of claim 4, wherein the substantially unique identification information is represented by a number printed upon the each plastic card.

7. The system of claim 6, wherein the number printed upon each plastic card is covered by a removable material.

8. The system of claim 7, wherein the removable material is configured to be scratched off of each plastic card.

9. The system of claim 1, wherein the value is represented by United States currency.

10. A method of providing value to a recipient, said method comprising the steps of:
providing for purchase one or more value objects comprised of substantially unique identification information;
allowing a purchaser to transmit the substantially unique identification information to at least one recipient;
providing value to the at least one recipient upon presentation of the substantially unique value object information.

11. The method of claim 10, wherein providing value to the at least one recipient is comprised of dispersal of currency.

12. The method of claim 10, wherein the one or more value objects are comprised of one or more plastic cards.

13. The method of claim 12, wherein the one or more plastic cards each contain at least one magnetic strip.

14. The method of claim 12, wherein the substantially unique identification information is represented by a number printed upon the each plastic card.

15. The method of claim 14, wherein the number printed upon each plastic card is covered by a removable material.

16. The method of claim 15, wherein the removable material is configured to be scratched off of each plastic card.

17. The method of claim 10, wherein the value is represented by United States currency.
